(19) United States
(12) Patent Application Publication
(10) Pub. No.: US 2025/0050621 A1
(43) Pub. Date: Feb. 13, 2025

(54) HIGH PERFORMANCE LAMINATED ALUMINUM ALLOY MANUFACTURING METHOD

(71) Applicant: JIMEI UNIVERSITY, Xiamen (CN)

(72) Inventors: Wenhui LIU, Xiamen (CN); Zhengzheng CHEN, Xiamen (CN); Xuefeng DING, Xiamen (CN); Xiao LIU, Xiamen (CN); Changping TANG, Xiamen (CN); Jianzhao WU, Xiamen (CN); Hao HUANG, Xiamen (CN)

(21) Appl. No.: 18/932,172

(22) Filed: Oct. 30, 2024

(30) Foreign Application Priority Data
Nov. 6, 2023 (CN) 202311462865.5
Jan. 4, 2024 (US) 18403756

(51) Int. Cl. B32B 15/01; C22C 21/00; C22F 1/04

(52) U.S. Cl. CPC B32B 15/016; C22F 1/04; B32B 2250/03; B32B 2311/24; B32B 2571/02; C22C 21/00

(57) ABSTRACT

A high performance laminated aluminum alloy manufacturing method includes: combining and fixing a front plate, a middle plate, and a rear plate, performing hot roll-bonding to obtain a laminated aluminum alloy; conducting solid solution and quenching treatment on the laminated aluminum alloy; carrying out underwater stirring friction treatment on the quenched laminated aluminum alloy; after aging heat treatment, the laminated aluminum alloy with high ballistic resistance and high interfacial bonding strength is obtained. The method uses underwater stirring friction treatment on quenched laminated aluminum alloy to break the original interlayer structure, forming a three-dimensional spatial structure composed of a stirring zone and a structural interlocked zone, and the interlayer bonding strength of the laminated aluminum alloy is greatly improved.

### CROSS REFERENCE TO THE RELATED APPLICATIONS

This application is based upon and claims priority to U.S. patent application Ser. No. 18/403,756 filed on Jan. 4, 2024 and Chinese patent application No. 202311462865.5 filed on Nov. 6, 2023, the entire contents of which are hereby incorporated by reference.

### TECHNICAL FIELD

The present invention relates to the technical field of manufacturing and processing of metal composites, and in particular to a high performance laminated armor aluminum alloy manufacturing method.

### BACKGROUND

Laminated armor aluminum alloy has advantages such as low density, high specific strength, and good welding performance. It also has better ballistic performance than single-layer armor aluminum alloy, which makes it become an ideal material for special vehicles such as amphibious armored vehicles and airborne armored vehicles. However, the interface of laminated aluminum alloy prepared by traditional methods is planar, and the bonding strength between component interfaces is greatly limited, and the cracks are easy to occur between layers.

Therefore, it is of great importance and practical value to develop a method for manufacturing a laminated aluminum alloy that is easy to operate, has high ballistic performance and high interfacial bonding.

### SUMMARY

The purpose of the present invention is to provide a high performance laminated armor aluminum alloy manufacturing method to solve the technical problem of poor interlayer bonding and easy delamination cracking of laminated aluminum alloys.

In order to achieve the purpose of the present invention, the present invention provides the following technical scheme:

The present invention provides a high performance laminated armor aluminum alloy manufacturing method, comprising the following steps:
Step (1): combining and fixing a rear plate, a middle plate, and a front plate to obtain a combined plate.
Step (2): After preheating the combined plate, the laminated aluminum alloy is obtained by roll-bonding
Step (3): conducting solid solution and quenching treatment to laminated aluminum alloy plates
Step (4): conducting underwater friction stir treatment after setting the weld-start plate and lead-out plates on the laminated aluminum alloy;
Step (5): carrying aging treatment on the laminated aluminum alloy after underwater friction stir treatment.

Further, said step (1) in which the front plate and the rear plate are both 7-series aluminum alloy or 2-series aluminum alloy, and the middle plate is pure aluminum.

Further, the surface treatment steps in said step (1) are: alkaline washing with 5-15 wt % NaOH solution for 3-10 min and then rinsing with 80-100° C. water, then acid washing with 5-15 wt % HNO₃ solution for 3-10 min and then rinsing with 5-25° C. water, and finally blowing dry, interface sanding treatment in sequence.

Further, said step (2) in which the preheating treatment temperature is 400-530° C., the preheating treatment time is 1 to 3 h.

Further, the temperature of solid solution treatment in said step (3) is 460-540° C. and the time of heat treatment is 1 to 4 h, then quenched with room temperature water.

Further, the underwater friction stir treatment in said step (4), the water temperature is room temperature, the stirring needle is provided with a thread, the length of the stirring needle is h, h_{f}+hₘ<h<h_{f}+hₘ+hᵣ, wherein, h_{f}, hₘ and hᵣ are the thickness of the front plate, the middle plate and the rear plate after roll-bonding in step (3), respectively; during underwater friction stir treatment, the stirring tool rotates into the laminated aluminum alloy from the front plate side, and the back tilt angle of the stirring tool is 1-3°; and the feed speed is 50-250 mm/min and the rotation speed is 400-2,500 r/min.

Further, the temperature of aging treatment in said step (5) is 100-200° C., and the time of aging treatment is 6 to 30 h.

### Beneficial Effect of the Present Invention

The present invention frictionally treats the laminated aluminum alloy by friction stir processing, and the interlayer structure in the stirred area is broken, and a three-dimensional spatial structure consisting of the nugget zone and an interlocked structural zone is formed. Since the strength of materials in the interlocked zone and the nugget zone is much higher than that of the bonding interface, therefore, the interfacial bonding strength of the laminated aluminum alloy is greatly improved.

The present invention refines the grain size through underwater stirring friction processing, and under the combined effect of plastic deformation introduced by stirring friction and plastic deformation promoting aging precipitation, the strength and ballistic resistance of aluminum alloy are improved.

The manufacturing method provided in the present invention is easy to operate and can be industrialized.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a schematic diagram of a high performance laminated armor aluminum alloy manufacturing method of the present invention, wherein: 1. front plate, 2. middle plate, 3. rear plate, 4. weld seam, 5. weld-start plate, 6. stirring tool, 7. lead-out plate, 8. rivet.

FIG. 2 shows the hardness distribution of the laminated aluminum alloy prepared in Embodiment 1.

FIG. 3 shows the cross-sectional morphology of the laminated aluminum alloy prepared in Embodiment 1.

FIG. 4 shows the cross-sectional morphology of the laminated aluminum alloy prepared in Contrast 1.

FIG. 5 shows the microstructure of the stirring zone of 7A62 aluminum alloy in Embodiment 1.

FIG. 6 shows the microstructure of the 7A62 aluminum alloy interlocked zone in Embodiment 1.

FIG. 7 shows the TEM of the stirring zone of 7A62 aluminum alloy in Embodiment 1.

FIG. 8 shows the TEM of the 7A62 aluminum alloy in Contrast 1.

### DETAILED DESCRIPTION OF THE EMBODIMENTS

The present invention provides a high performance laminated armor aluminum alloy manufacturing method, comprising the following steps:
Step (1): combining and fixing a rear plate, a middle plate, and a front plate to obtain a combined plate.
Step (2): After preheating the combined plate, the laminated aluminum alloy is obtained by roll-bonding
Step (3): conducting solid solution and quenching treatment to laminated aluminum alloy plates
Step (4): conducting underwater friction stir treatment after setting the weld-start plate and lead-out plates on the laminated aluminum alloy;
Step (5): carrying aging treatment on the laminated aluminum alloy after underwater friction stir treatment.

In the present invention, said step (1) in which the front plate and the rear plate are both 7-series aluminum alloy or 2-series aluminum alloy, and the middle plate is pure aluminum; preferably, the rear plate is 7N01 aluminum alloy, 7A52 aluminum alloy or 2519 aluminum alloy, and the front plate is 7A62 aluminum alloy, 7055 aluminum alloy or 2195 aluminum alloy; further preferably, the rear plate is 7A52 aluminum alloy or 2519 aluminum alloy, and the front plate is 7A62 aluminum alloy or 2195 aluminum alloy.

In the present invention, the surface treatment steps in said step (1) are: alkaline washing with 5-15 wt % NaOH solution for 3-10 min and then rinsing with 80-100° C. water, then acid washing with 5-15 wt % HNO₃ solution for 3-10 min and then rinsing with 5-25° C. water, and finally blowing dry, interface sanding treatment in sequence; preferably with 7-12 wt % of NaOH solution alkaline wash 4-8 min after rinsing with 85-95° C. water, then with 7-12 wt % of HNO₃ solution acid wash 4-8 min after rinsing with 8-20° C. water, and finally blow dry, interface polishing treatment in turn; further preferably with 10 wt % of NaOH solution alkaline wash 5 min after rinsing with 90° C. water, then with 10 wt % of HNO₃ solution acid wash 5 min after rinsing with 10° C. water, and finally blow dry, interface polishing treatment in turn

In the present invention, said step (2) in which the preheating treatment temperature is 400-530° C. When the front plate and the rear plate are both 7-series aluminum alloy, the preheating treatment temperature is preferably 400-470° C., further preferably 410-460° C., further preferably 420-450° C.; When the front plate and the rear plate are both 2-series aluminum alloy, the preheating treatment temperature is preferably 440-530° C., further preferably 450-520° C., further preferably 460-510° C. The preheating treatment time is 1 to 3 h, preferably 1.5-2.5 h, further preferably 2 h.

In the present invention, the temperature of solid solution treatment in said step (3) is 460-540° C. When the front plate and the rear plate are both 7-series aluminum alloy, the solid solution temperature is preferably 460-480° C., further preferably 465-475° C.; When the front plate and the rear plate are both 2-series aluminum alloy, the solid solution temperature is preferably 510-540° C., further preferably 525-535° C. The solid solution time is 1 to 4h, preferably 1.5-3.5h, further preferably 2-3 h, then quenched with room temperature water.

In the present invention, the underwater friction stir treatment in said step (4), the water temperature is room temperature, the stirring needle is provided with a thread, the length of the stirring needle is h, h_{f}+hₘ<h<h_{f}+hₘ+hᵣ, wherein, h_{f}, hₘ and hᵣ are the thickness of the front plate, the middle plate and the rear plate after roll-bonding in step (3), respectively; during underwater friction stir treatment, the stirring tool rotates into the laminated aluminum alloy from the front plate side, and the back tilt angle of the stirring tool is 1-3°; and the feed speed is 50-250 mm/min, preferably 60-240 mm/min, further preferably 80-220 mm/min; and the rotation speed is 400-2,500 r/min, preferably 450-2,400 r/min, further preferably 500-2,200 r/min.

In the present invention, the temperature of aging treatment in said step (5) is 100-200° C. When the front plate and the rear plate are both 7-series aluminum alloy, the aging temperature is preferably 110-130° C., further preferably 115-125° C.; When the front plate and the rear plate are both 2-series aluminum alloy, the aging temperature is preferably 150-180° C., further preferably 155-175° C. The time of aging treatment is 6 to 30 h, preferably 10-28 h, further preferably 12-24 h.

In the following, the technical scheme provided by the present invention will be described in detail with reference to the embodiments, but they should not be construed as limiting the scope of the present invention.

### Embodiment 1

Firstly, the 7A52 aluminum alloy rear plate with thickness of 17 mm, the pure aluminum middle plate with thickness of 1 mm, and the 7A62 aluminum alloy front plate with thickness of 17 mm are subjected to surface treatment: alkaline wash with 10 wt % NaOH solution for 5 min and then rinse with 80° C. water, then acid wash with 10 wt % HNO₃ solution for 5 min and then rinse with 10° C. water, and finally blow dry with hot air and use steel wire brush to polish, then combine the rear plate, middle plate and front plate, drill holes in the front and rear ends of the combined plate, and fix them with aluminum rivets to obtain the combined plate;

Conduct the roll bonding after heat treatment of the combined plate for 2 h at 420° C., and the thickness of the laminated aluminum alloy obtained is 7 mm, wherein h_{f}+hₘ is about 3.6 mm;

Conduct the solid solution of 470° C./2 h+water quenching on the laminated aluminum alloy plate;

Set the 7 mm thick aluminum alloy weld-start plate and lead-out plate on the laminated aluminum alloy of thickness 7 mm, and then carrying out underwater friction stir treatment, wherein the stirring needle is provided with a thread, the length of the stirring needle is 4.3 mm, the stirring needle rotates in from the side of the 7A62 aluminum alloy front plate, the back tile angle of the stirring tool is 2°, the feed speed is 100 mm/min and the stirring rotation speed is 1,750 r/min during the friction stir treatment;

Aging the laminated aluminum alloy at 120° C. for 24 hours to obtain high-performance 7A62/Al/7A52 laminated aluminum alloy.

### Contrast 1

Firstly, the 7A52 aluminum alloy rear plate with thickness of 17 mm, the pure aluminum middle plate with thickness of 1 mm, and the 7A62 aluminum alloy front plate with thickness of 17 mm are subjected to surface treatment: alkaline wash with 10 wt % NaOH solution for 5 min and then rinse with 80° C. water, then acid wash with 10 wt % HNO₃ solution for 5 min and then rinse with 10° C. water, and finally blow dry with hot air and use steel wire brush to polish, then combine the rear plate, middle plate and front plate, drill holes in the front and rear ends of the combined plate, and fix them with aluminum rivets to obtain the combined plate;

After preheating the combined plate at 420° C./2 h, a laminated aluminum alloy plate with a total thickness of 7 mm is obtained by rolling;

Solid solution at 470° C./2 h, water quenching, aging treatment at 120° C./24 h on laminated aluminum alloy plates.

### Embodiment 2

Firstly, the 2519 aluminum alloy rear plate with thickness of 17 mm, the pure aluminum middle plate with thickness of 1 mm, and the 2195 aluminum alloy front plate with thickness of 17 mm are subjected to surface treatment: alkaline wash with 10 wt % NaOH solution for 5 min and then rinse with 80° C. water, then acid wash with 10 wt % HNO₃ solution for 5 min and then rinse with 10° C. water, and finally blow dry with hot air and use steel wire brush to polish, then combine the rear plate, middle plate and front plate, drill holes in the front and rear ends of the combined plate, and fix them with aluminum rivets to obtain the combined plate;

Conduct the roll bonding after heat treatment of the combined plate for 2 h at 480° C., and the thickness of the laminated aluminum alloy obtained is 7 mm, wherein h_{f}+hₘ is about 3.6 mm;

Conduct the solid solution of 530° C./2 h+water quenching on the laminated aluminum alloy plate;

Set the 7 mm thick aluminum alloy weld-start plate and lead-out plate on the laminated aluminum alloy of thickness 7 mm, and then carrying out underwater friction stir treatment, wherein the stirring needle is provided with a thread, the length of the stirring needle is 5.0 mm, the stirring needle rotates in from the side of the 2195 aluminum alloy front plate, the back tile angle of the stirring tool is 2°, the feed speed is 100 mm/min and the stirring rotation speed is 1,500 r/min during the friction stir treatment;

Aging the laminated aluminum alloy at 165° C. for 12 hours to obtain high-performance 2195/Al/2519 laminated aluminum alloy.

### Contrast 2

Firstly, the 2519 aluminum alloy rear plate with thickness of 17 mm, the pure aluminum middle plate with thickness of 1 mm, and the 2195 aluminum alloy front plate with thickness of 17 mm are subjected to surface treatment: alkaline wash with 10 wt % NaOH solution for 5 min and then rinse with 80° C. water, then acid wash with 10 wt % HNO₃ solution for 5 min and then rinse with 10° C. water, and finally blow dry with hot air and use steel wire brush to polish, then combine the rear plate, middle plate and front plate, drill holes in the front and rear ends of the combined plate, and fix them with aluminum rivets to obtain the combined plate;

After preheating the combined plate at 480° C./2h, a laminated aluminum alloy plate with a total thickness of 7 mm is obtained by rolling;

Solid solution at 530° C./2 h, water quenching, aging treatment at 165° C./12 h on laminated aluminum alloy plates.

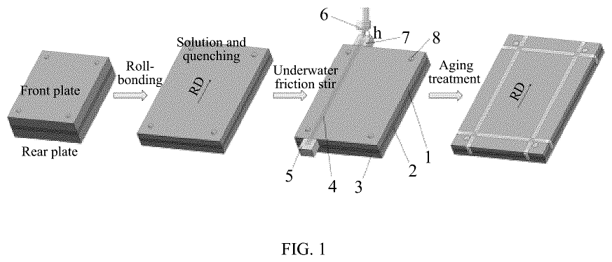

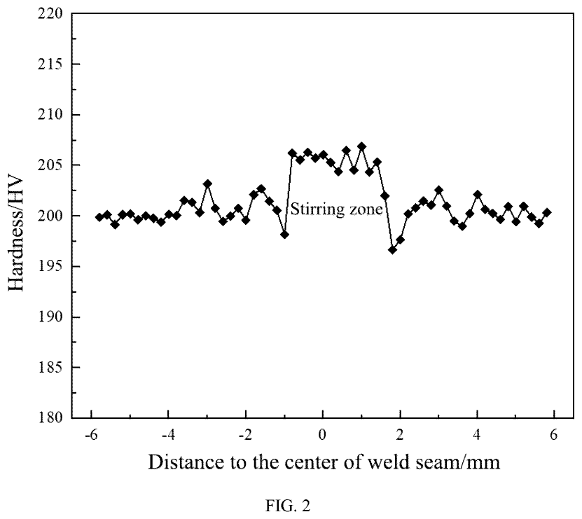

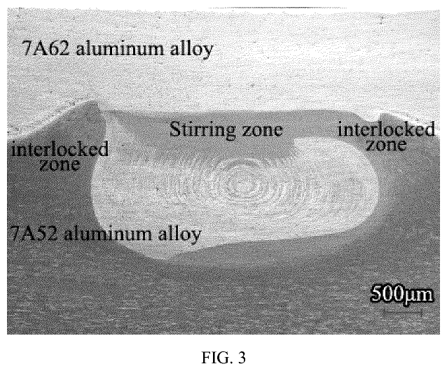

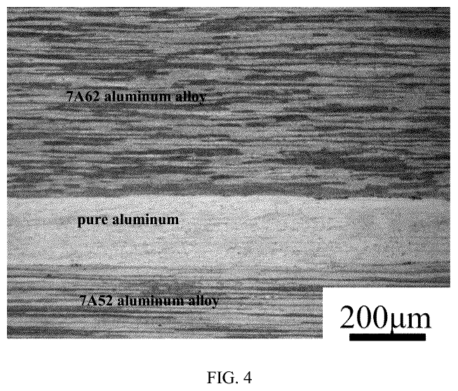

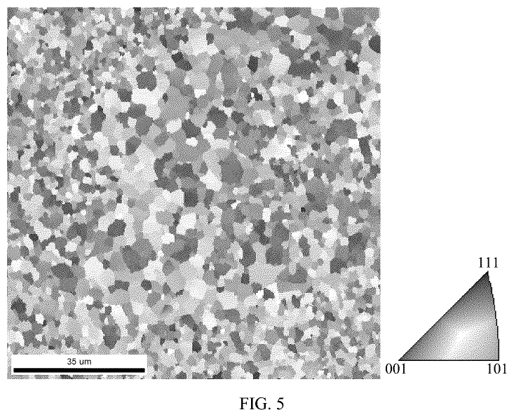

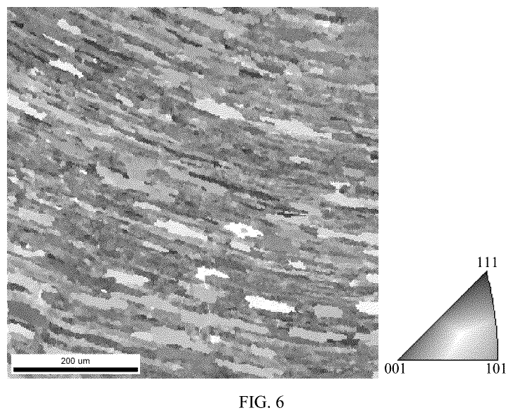

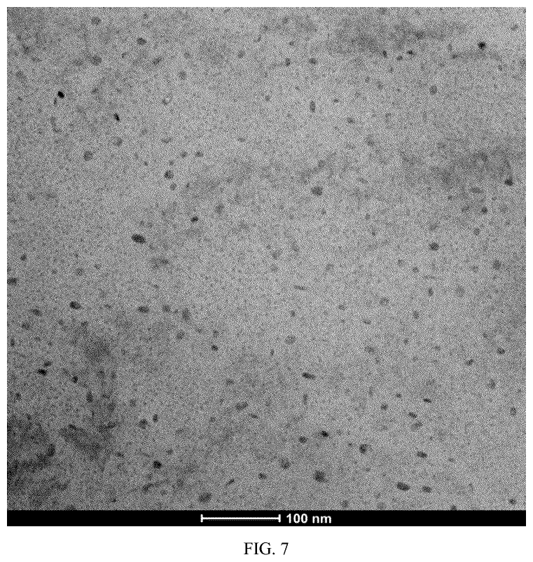

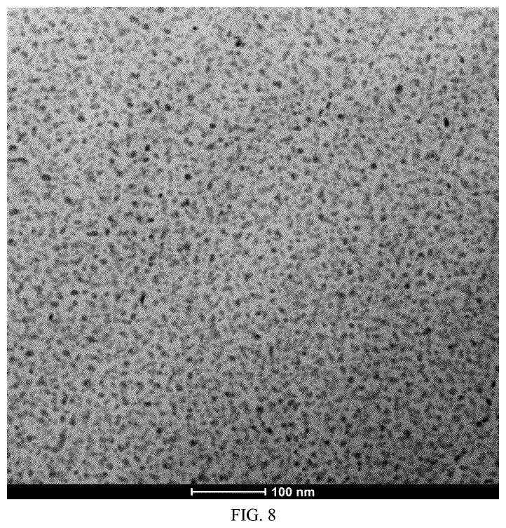

From the above embodiments, it can be seen that the present invention provides a manufactural method for high-performance laminated armor aluminum alloy, as shown in FIG. 1. FIG. 2 shows the hardness distribution of the 7A62 aluminum alloy front plate of the laminated aluminum alloy in Embodiment 1. It can be seen that after the treatment of the present invention, the hardness of the stir zone is significantly higher than that of the base material zone. FIG. 3 and FIG. 4 respectively show the cross-sectional morphology of the laminated aluminum alloy in Embodiment 1 and the Contrast 1. From FIG. 3, it can be seen that the friction stir treatment has made the interlayer structure broken, the high temperature and plastic flow generated by stirring friction form the stirring zone, and the material plastic flow at the vertical interface caused by stirring friction forms an effective structural interlocked zone, thus constructing a three-dimensional spatial structure composed of the stirring zone and the interlocked zone, which breaks through the limitation of traditional laminated aluminum alloy materials with a flat interface (FIG. 4). FIG. 5 and FIG. 6 respectively show the microstructure of the stirring zone and interlocked zone of the 7A62 aluminum alloy panel in Embodiment 1. It can be seen that the grains of the 7A62 aluminum alloy in the stirring zone are refined, and the grain size in the interlocked zone changes slightly, but rotation occurs under the action of the stirring friction. FIG. 7 shows TEM picture of precipitates near the stirring zone of 7A62 aluminum alloy in Embodiment 1, while FIG. 8 shows the precipitates of 7A62 aluminum alloy in Contrast 1. It can be seen that the precipitates in FIG. 7 are finer and more dispersed due to the plastic deformation increasing the dislocation and vacancy density of 7A62 aluminum alloy. Under the combined effects of grain refinement, plastic deformation introduced by stirring friction and plastic deformation promoting aging precipitation, the strength and ballistic resistance performance of laminated aluminum alloys are greatly improved. Using tensile shear experiments to test the interlayer shear strength of laminated aluminum alloys, and using Hopkinson high-speed impact experiments (ϕ6 mm×4 mm cylindrical specimen with a strain rate of 3000 s⁻¹) to test the ballistic performance of laminated aluminum alloy. The interlayer shear strength and impact energy absorption of Embodiment 1 were 196.1 MPa and 112.8 MJ/m³, respectively. For the Contrast 1, the interlayer shear strength and impact energy absorption were 83.1 MPa and 98.7 MJ/m³, respectively. The interlayer shear strength and impact energy absorption of Embodiment 2 were 198.2 MPa and 120.5 MJ/m³, respectively. For the Contrast 2, the interlayer shear strength and impact energy absorption were 85.6 MPa and 103.5 MJ/m³, respectively.

it can be seen that the present invention provides a method for preparing high-performance laminated armor aluminum alloy. Firstly, the front plate, middle plate, and rear plate are combined and fixed, and the combined plate is subjected to hot roll bonding treatment. Then, the obtained laminated aluminum alloy is subjected to solid solution and quenching treatment, followed by underwater stirring friction treatment on the quenched laminated aluminum alloy, and finally, aging treatment, obtain laminated aluminum alloys with high interfacial bonding strength and high ballistic resistance performance. The laminated aluminum alloy prepared by the present invention breaks through the limitation of the traditional layered aluminum alloy material with a planar interface, and prepares a layered aluminum alloy with a spatial structure, greatly improving the interlayer bonding strength. The underwater stirring friction processing refined the grain size, introduced plastic deformation promoted subsequent aging precipitation. Under the combined effects of grain refinement, strain strengthening, and precipitation strengthening, the strength and ballistic resistance performance of laminated aluminum alloys have been improved.

The foregoing is only a preferred embodiment of the present invention. It should be pointed out that for those of ordinary skill in the art, several modifications and improvements can be made without departing from the principles of the present invention, and these modifications and improvements should also be considered as the scope of the present invention.

What is claimed is:

1. A high performance laminated armor aluminum alloy manufacturing method, comprising the following steps:
step (1): combining and fixing a rear plate, a middle plate, and a front plate to obtain a combined plate;
step (2): after preheating the combined plate, obtaining a laminated aluminum alloy by roll-bonding;
step (3): conducting solid solution and quenching treatment to laminated aluminum alloy plates;
step (4): conducting underwater friction stir treatment after setting a weld-start plate and lead-out plates on the laminated aluminum alloy; and
step (5): carrying aging treatment on the laminated aluminum alloy after underwater friction stir treatment.

2. The high performance laminated armor aluminum alloy manufacturing method according to claim 1, wherein step (1), the front plate and the rear plate are both 7-series aluminum alloy or 2-series aluminum alloy, and the middle plate is pure aluminum.

3. The high performance laminated armor aluminum alloy manufacturing method according to claim 1, wherein step (1), the surface treatment steps are: alkaline washing with 5-15 wt % NaOH solution for 3-10 min and then rinsing with 80-100° C. water, then acid washing with 5-15 wt % HNO₃ solution for 3-10 min and then rinsing with 5-25° C. water, and finally blowing dry, interface sanding treatment in sequence.

4. The high performance laminated armor aluminum alloy manufacturing method according to claim 3, wherein step (2), a preheating treatment temperature is 400-530° C., and a preheating treatment time is 1 to 3 h.

5. The high performance laminated armor aluminum alloy manufacturing method according to claim 4, wherein step (3), a temperature of solid solution treatment is 460-540° C., and a time of heat treatment is 1 to 4 h, then quenched with room temperature water.

6. The high performance laminated armor aluminum alloy manufacturing method according to claim 5, wherein step (4), the water temperature is room temperature, a stirring needle is provided with a thread, a length of the stirring needle is h, h_{f}+hₘ<h<h_{f}+hₘ+hᵣ, wherein h_{f}, hₘ and hᵣ are a thickness of the front plate, a thickness of the middle plate and a thickness of the rear plate after roll-bonding in step (3), respectively; during underwater friction stir treatment, a stirring tool rotates into the laminated aluminum alloy from the front plate side, and a back tilt angle of the stirring tool is 1-3°; and a feed speed is 50-250 mm/min and a rotation speed is 400-2,500 r/min.

7. The high performance laminated armor aluminum alloy manufacturing method according to claim 6, wherein step (5), a temperature of aging is 100-200° C., and a time of aging treatment is 6 to 30 h.

8. The high performance laminated armor aluminum alloy manufacturing method according to claim 2, wherein step (1), the surface treatment steps are: alkaline washing with 5-15 wt % NaOH solution for 3-10 min and then rinsing with 80-100° C. water, then acid washing with 5-15 wt % HNO₃ solution for 3-10 min and then rinsing with 5-25° C. water, and finally blowing dry, interface sanding treatment in sequence.

9. The high performance laminated armor aluminum alloy manufacturing method according to claim 8, wherein step (2), a preheating treatment temperature is 400-530° C., and a preheating treatment time is 1 to 3 h.

10. The high performance laminated armor aluminum alloy manufacturing method according to claim 9, wherein step (3), a temperature of solid solution treatment is 460-540° C., and a time of heat treatment is 1 to 4 h, then quenched with room temperature water.

11. The high performance laminated armor aluminum alloy manufacturing method according to claim 10, wherein step (4), the water temperature is room temperature, a stirring needle is provided with a thread, a length of the stirring needle is h, hᵣ+hₘ<h<h_{f}+hₘ+hᵣ, wherein h_{f}, hₘ and hᵣ are a thickness of the front plate, a thickness of the middle plate and a thickness of the rear plate after roll-bonding in step (3), respectively; during underwater friction stir treatment, a stirring tool rotates into the laminated aluminum alloy from the front plate side, and a back tilt angle of the stirring tool is 1-3°; and a feed speed is 50-250 mm/min and a rotation speed is 400-2,500 r/min.

12. The high performance laminated armor aluminum alloy manufacturing method according to claim 11, wherein step (5), a temperature of aging is 100-200° C., and a time of aging treatment is 6 to 30 h.
